(19) United States
(12) Patent Application Publication
(10) Pub. No.: US 2008/0168273 A1
(43) Pub. Date: Jul. 10, 2008

(54) CONFIGURATION MECHANISM FOR FLEXIBLE MESSAGING SECURITY PROTOCOLS

(76) Inventors: Hyen V. Chung, Round Rock, TX (US); Yasumasa Kajinaga, Yokohama-shi (JP); Yuichi Nakamura, Yokohama-shi (JP); Fumiko Satoh, Tokyo (JP); Masayoshi Teraguchi, Yokohama-shi (JP)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/620,477

(22) Filed: Jan. 5, 2007

(51) Int. Cl. H04L 9/00

(52) U.S. Cl. 713/172

(57) ABSTRACT

Methods and arrangements to handle network messages containing security information are disclosed. Embodiments include transformations, code, state machines or other logic to handle network messages containing security information by configuring an application to generate and process security information of network messages. An embodiment may involve creating a data structure to store security information of network messages and storing security information in the data structure. The security information may include a specification of a cryptographic key, a format to represent information about the cryptographic key, a policy to select a security token of a requestor when multiple security tokens are contained in network messages, or a policy to select a security token to determine the degree of trust to provide a message sender. The embodiment may include the generation of security information or consumption of security information of a message utilizing security information stored in the data structure.

### FIELD

The present invention is in the field of data security. More particularly, the present invention relates to methods and arrangements to provide security to messages sent over a network.

### BACKGROUND

Elaborate protocols have been devised to provide security for network messages. This provision of security is important. The data contained in network messages may represent the intellectual capital of a business and form a significant portion of its value. The loss or alteration of the data may represent a loss of capital and may seriously harm the business. In addition, a business may have a legal or contractual duty to preserve the confidentiality of data stored in computer form, such as medical records, credit card numbers, and social security numbers. Allowing unauthorized persons to access the data violates the duty and may expose the business to liability.

Providing security to network messages may include transforming the contents of the messages and adding security information to the messages. The transforming may include encrypting a portion of the contents, generating a numeric summary of the contents (digest) to show that the contents of messages have not changed during transmission, and signing the message to prove the identity of the sender (authentication) and to prevent repudiation of a transaction. The security information may describe the transformations and may include the results of the transformations, to enable a recipient to process the messages. It may also provide evidence to authenticate or otherwise demonstrate the trustworthiness of the sender and receiver of the messages. The information about transformations may describe the use of cryptographic keys for encryption and the digital signatures which were performed on the message. The transformation information may also include the encrypted contents, the values of the digests, and the values of the signatures. The evidence of authentication and trustworthiness may include digital certificates and security tokens.

Security protocols may require a detailed description of the elements of security information. For example, Web Services Security Version 1.0 (WSS), a specification originally submitted to the Organization for the Advancement of Structured Information Standards (OASIS) by IBM, Microsoft, and VeriSign, Inc., provides a protocol for including security information in messages concerned with Web services. The generation and processing of security information for protocols which require detailed descriptions of security elements may prove laborious under current methods. In order to generate the security information, for example, users may be required to specify a large number of parameters. In one approach, users may be forced to specify all security features one by one, even though the information required to supply some parameters may have been furnished in supplying other parameters. For example, even though a user has referred to an X.509 certificate in a SecurityTokenReference or Reference element, the user may be required to supply information about the X.509 certificate in a KeyIdentifier or X509IssuerSerial element. In addition, existing security processors may not allow the reuse of security information. A user that constructs a set of bindings of parameters for use with one message may have to construct the set of bindings from scratch for another message.

### SUMMARY OF THE INVENTION

The problems identified above are in large part addressed by methods and arrangements to handle network messages containing security information. One embodiment provides a method to configure an application to generate network messages. The method may involve creating a data structure to store security information of network messages and storing security information in the data structure. The security information may include a specification of a cryptographic key and a specification of a format to represent information about the cryptographic key. The method may include the application generating security information for a network message. The generation may include accessing the specification of a cryptographic key and the specification of a format. Another embodiment provides a method to configure an application to process network messages. The method may include creating a data structure to store security information of network messages and storing security information in the data structure. The security information may include a specification of a method to select a security token of a requestor when multiple security tokens are contained in network messages. The method may include the application processing a network message by applying the method to select a security token. The security information may also include a specification of a method to select a token to determine a degree of trust.

### BRIEF DESCRIPTION OF THE DRAWINGS

Advantages of the invention will become apparent upon reading the following detailed description and upon reference to the accompanying drawings in which like references may indicate similar elements:

FIG. 1 depicts a diagram of an embodiment of a networked system of devices capable of handling network messages containing security information;

FIG. 2 depicts an embodiment of a computer capable of handling network messages containing security information;

FIG. 3 depicts a process flow diagram of the insertion of security information in a message;

FIG. 4 depicts the specification of bindings from collections of prepared bindings;

FIG. 5 depicts a process flow diagram of the processing of security information in a message;

FIG. 6 depicts the processing of security information by a consumer of security information; and

FIG. 7 depicts a flowchart of an embodiment to configure an application to generate security information.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

Generally speaking, methods and arrangements to handle network messages containing security information are contemplated. Embodiments include transformations, code, state machines or other logic to handle network messages containing security information by configuring an application to generate security information of network messages. An embodiment may involve creating a data structure to store security information of network messages and storing security information in the data structure. The security information may include a specification of a cryptographic key and a specification of a format to represent information about the cryptographic key. The embodiment may include the application generating a network message. The generation may include accessing the specification of a cryptographic key and the specification of a format. Another embodiment may involve configuring an application to process network messages. The embodiment may include creating a data structure to store security information of network messages and storing security information in the data structure. The security information may include a specification of a method to select a security token as the identity of a requestor when multiple security tokens are contained in network messages. The embodiment may include the application processing a network message by applying the method to select a security token. The embodiment may also include a specification of a method to select a trust token when multiple security tokens are contained in network messages.

While specific embodiments will be described below with reference to particular circuit or logic configurations, those of skill in the art will realize that embodiments of the present invention may advantageously be implemented with other substantially equivalent configurations.

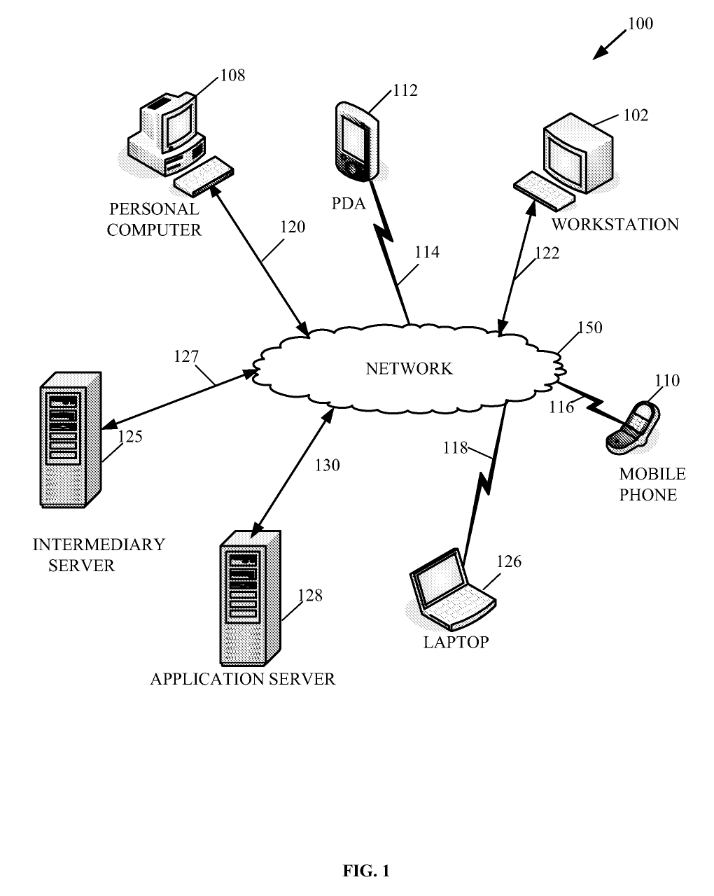

FIG. 1 depicts a diagram of an embodiment of a networked system 100 of devices capable of handling network messages containing security information. Networked system 100 may provide for the transmission of messages containing security information over the Internet and other networks. The system 100 includes a network 150, intermediary server 125 connected to network 150 through wireline connection 127, application server 128 connected to network 150 through wireline connection 130, and a variety of devices capable of handling network messages containing security information (message devices), including:
workstation 102, a computer coupled to network 150 through wireline connection 122,
personal digital assistant 112, coupled to network 150 through wireless connection 114,
personal computer 108, coupled to network 150 through wireline connection 120,
laptop computer 126, coupled to network 150 through wireless connection 118; and
mobile phone 110, coupled to network 150 through wireless connection 116.
   The messages devices may generate, transmit, receive, and process messages containing security information over network 150.

Network 150, which may consist of the Internet or another wide area network, a local area network, or a combination of networks, may provide data communications among the intermediary server 125, application server 128, and message devices 102, 108, 112, 126, and 110. Intermediary server 125 may have installed and operative upon it software to receive, process, and transmit messages containing security information across network 150. Intermediary server 125 may, for example, operate as an intermediary node for Web services. Web services provide a standardized way of integrating web-based applications. Web services typically provide business services upon request through data communications. Web services intermediaries are Web services components, typically servers, that lie between Web services requesters and Web services ultimate destination servers that deliver the Web services. Intermediaries operate generally by intercepting a request from a client, optionally providing intermediary services, and then forwarding the request to an ultimate destination Web services provider. Similarly, responses from the Web services provider may be intercepted, optionally operated upon, and then returned to the original requester.

Application server 128 may run software applications requested by client computers such as message devices 102, 108, 112, 126, and 110. One example of an application server is IBM® WebSphere® application server. Application server 128 may have installed and operative upon it software to handle network messages containing security information across network 150. Application server 128 may generate security information, insert the information in messages, and transmit the messages over network 150. Conversely, application server 128 may receive messages over network 150 and process the security information contained in them.

Application server 128 may configure applications to generate network messages by creating data structures to store security information for the messages. The information may include specifications of cryptographic keys and specifications of formats to represent information about the cryptographic keys. Applications running under application server 128 may access the data structures to generate network messages. Message devices such as devices 102, 108, 112, 126, and 110 may handle security information in messages. They may generate security information, insert the information in messages, send the messages, receive messages containing security information, and process the security information.

The arrangement of the server and other devices making up the exemplary system illustrated in FIG. 1 is for explanation, not for limitation. Data processing systems useful according to various embodiments of the present invention may omit a server, or may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

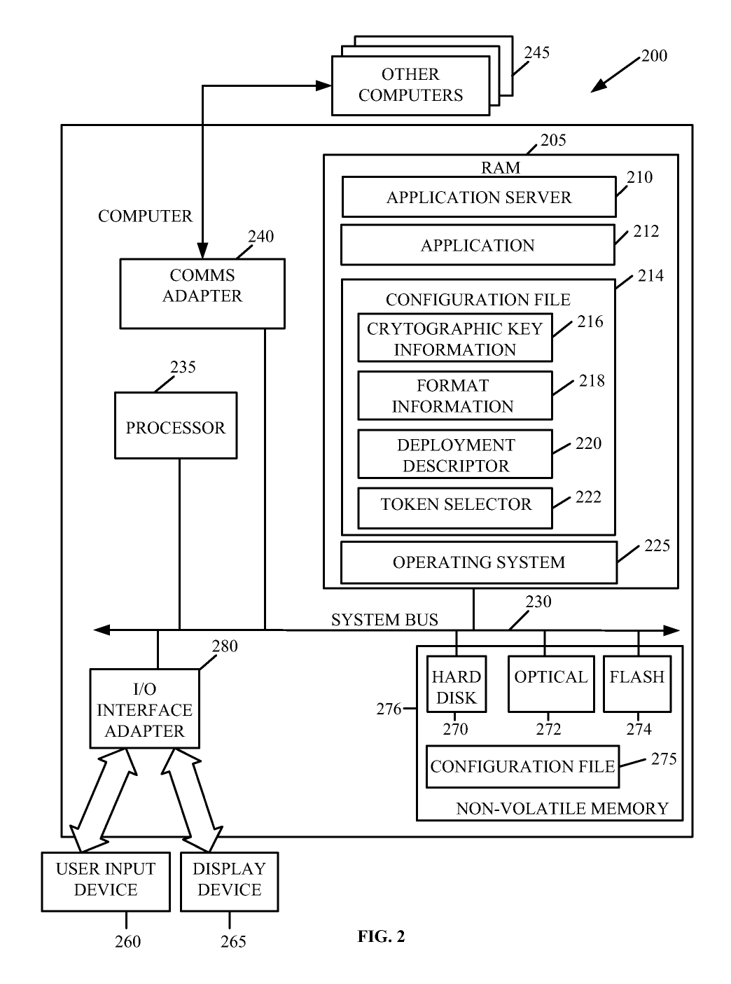

Turning to FIG. 2, depicted is an embodiment of a computer 200 capable of handling network messages containing security information that includes random access memory (RAM) 205, a processor 235 or CPU, non-volatile memory 276, a communications adapter 240, and an Input/Output (I/O) interface adapter 280 connected by system bus 230. Stored in RAM 205 is application server 210, application 212, configuration file 214, and operating system 225.

Application server 210 may comprise computer program instructions to run software applications requested by clients. Application server 210 may configure applications such as application 212 to process security information in messages. Application server 210 may create configuration file 214 and load it into RAM 205 for the use of applications such as application 212 in processing security information in messages. Configuration file 214 may include cryptographic key information 216, format information 218, deployment descriptor 220, and token selector 222. Cryptographic key information 216 may contain specifications of information about cryptographic keys for use in processing security information. Format information 218 may contain specifications of formats to represent cryptographic keys. Deployment descriptor 220 may describe the security requirements for network messages. For example, the deployment descriptor 220 for an application that performs Web services may describe the application of Web Services Security to messages. Token selector 222 may describe the selection of tokens by a consumer of network messages. For example, token selector 222 may describe which token to select to identify a sender of a message and which token to select as a trust token when the security information of a message contains multiple tokens.

Configuration file 214 may also include a specification of how to use cryptographic keys, how to sign or encrypt network messages, how to reference or include cryptographic keys in the network messages, what tokens to include in a generated message, and what tokens are required in messages to be consumed. Configuration file 214 may contain a complete specification of the generation or consumption of security information for network messages. In particular, configuration file 214 may contain specifications of security information for Web Services. The specifications may be based on the Web Service Security 1.0 specification from the Organization for the Advancement of Structured Information Standards (OASIS). Applications such as application 212 may access configuration file 214 in processing security information during the generation and consumption of messages.

Operating system 225 may comprise UNIX™, Linux™, Microsoft Windows™, AIX™, IBM's i5/OS™, or other operating systems useful for handling network messages containing security information as will occur to those of skill in the art. Application server 210, application 212, configuration file 214, and operating system 225 (components of software) are shown in RAM 205 in FIG. 2, but many components of such software may be stored in non-volatile memory 276 also. Further, while the components of such are shown simultaneously present in RAM, in other embodiments, only some of the components of RAM 205 may be present at any given time

I/O interface adapter 280 implements user-oriented I/O through, for example, software drivers and computer hardware for controlling output to display devices such as display device 265 as well as user input from user input device 260. User input device 260 may include both a keyboard and a mouse. Some embodiments may include other user input devices such as speech interpreters, bar code scanners, text scanners, tablets, touch screens, and/or other forms of user input devices. Non-volatile computer memory 276 may be implemented as a hard disk drive 270, optical disk drive 272, electrically erasable programmable read-only memory space (EEPROM or Flash memory) 274, RAM drives (not shown), or as any other kind of computer memory as will occur to those of skill in the art. Non-volatile computer memory 276 may contain configuration file 275. All or portions of configuration file 275 may be loaded into RAM 205 for the generation and consumption of security information.

Communications adapter 240 may implement the hardware level of data communications through which one computer sends data communications, such as messages containing security information, to other computers, such as other computers 245, directly or through a network. Such data communications may be carried out through serially through RS-232 connections, through external buses such as USB, through data communications networks such as IP networks, and in other ways as will occur to those of skill in the art. Examples of communications adapters include modems for wired dial-up communications, Ethernet (IEEE 802.3) adapters for wired network communications, and 802.11b adapters for wireless network communications.

The computer and components illustrated in FIG. 2 are for explanation, not for limitation. In other embodiments, modules to handle the security information in messages transmitted over a network may be implemented in hardware, firmware, or in state machines or may form a component of an operating system.

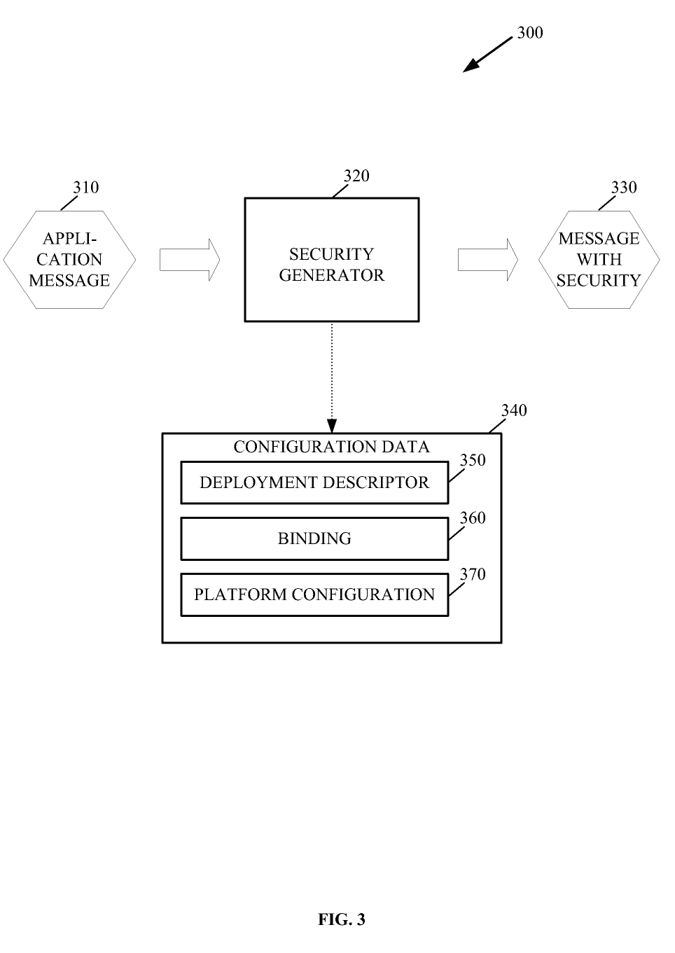

FIG. 3 is a process flow diagram 300 of the insertion of security information in a message. FIG. 3 includes application message 310, security generator 320, message with security 330, and configuration data 340. Application message 310 is a message produced by an application for transmission over a network. The application may, for example, perform Web services or may request a Web service.

Message 310 is received by security generator 320. Security generator 320 may be a component of the application that produced application message 310, or may be a separate module for processing security information, such as a Web services security module. Security generator 320 may process message 310 to provide security, thereby producing message with security 330. The processing includes accessing configuration data 340 to obtain security information to insert in application message 310.

Providing message security may involve encryption, digesting or hashing, signing, authentication, claims, and establishing trust. Encryption is the process of transforming information into a form which is readily understandable. Sending a message in encrypted form may prevent someone who intercepts the message from understanding the contents. The reverse process, decryption, involves restoring the information to an understandable form. Cryptography includes both processes. Often cryptography uses a secret piece of information, called a key, to perform the encryption and decryption. Typically, the key is an input to a mathematical algorithm that performs the transformations. The algorithm may be symmetric or asymmetric. Symmetric algorithms use the same key for encryption and decryption. Asymmetric algorithms use a pair of keys, often a public key and a private key obtained from a public key/private key infrastructure. An authority may issue certificates verifying the identity of the issuer of a public key.

A hash or digest is a mathematical transformation of the contents of a message or other document into a short string of data, such as 160 bits. The transformation is designed to be one-way—to be difficult to construct a message with a given hash value. A hash may be used to show the integrity of data transmitted across a network. A recipient of the message may be provided with the hash algorithm and the value resulting from a hash of the message before transmission. The recipient may perform a hash of the message as received. If the two hash values are equal and the recipient trusts that the hash value was not tampered with in transmission, the recipient may trust that the message was not changed during transmission.

A signature combines hashing and encryption, and may be used both to authenticate the signer and to show the integrity of the contents of the message. A signature or digital signature is a transformation of a message that can only be produced by use of certain private information. The creation of the signature proves possession of the private information. Signing a message is often carried out by hashing a message and encrypting the hash with the signor's private key in a public key/private key infrastructure. A recipient may verify a signature by decrypting the signature with the signor's public key, thereby obtaining a purported hash of the request. The recipient may compare the purported hash with a hash of the message as received. The equality of the two hashes confirms both the identity of the sender and the integrity of the message. The sender is known, since the public key can only decrypt a message encrypted with the sender's private key. Presumably, only the sender has access to that key. Further, the integrity of the message during transmission is verified. Had the message been changed in transmission, the hash of the message as sent would not equal the hash of the message as received.

In providing security for a network message, security generator 320 may insert security information in the message. The security information may describe the security processing and may include evidence of the reliability of the contents of the message or the transmitters of the message. The following example of a portion of a SOAP message illustrates the security information that may be inserted in a message:

```
<?xml version=“1.0” encoding=“utf-8”?>
<S:Envelope xmlns:S=“http://www.w3.org/2001/12/soap-envelope”
xmlns:ds=“http://www.w3.org/2000/09/xmldsig#”>
  <S:Header>
    <wsse:Security
    xmlns:wsse=“http://schemas.xmlsoap.org/ws/2002/04/secext”>
        <wsse:BinarySecurityToken ValueType=“wsse:X509v3“...
        wsu:Id=“X509Token”>
        MIIEZzCCA9CgAwIBAgIQEmtJZc0rqrKh5i...
        </wsse:BinarySecurityToken>
      <ds:Signature>
        <ds:SignedInfo>
          <ds:CanonicalizationMethod
            Algorithm=“http://www.w3.org/2001/10/xml-exc-c14n#”/>
          <ds:SignatureMethod
          Algorithm=“http://www.w3.org/2000/09/xmldsig#hmac-
          sha1”/>
          <ds:Reference URI=“#MsgBody”>
          <ds:DigestMethod
          Algorithm=“http://www.w3.org/2000/09/xmldsig#sha1”/>
          <ds:DigestValue>LyLsF0Pi4wPU...</ds:DigestValue>
          </ds:Reference>
        </ds:SignedInfo>
      <ds:SignatureValue>DJbchm5gK...</ds:SignatureValue>
      <ds:KeyInfo>
      <wsse:SecurityTokenReference>
      <wsse:Reference URI=“#X509Token”/>
      </wsse:SecurityTokenReference>
      </ds:KeyInfo>
    </ds:Signature>
  </wsse:Security>
</S:Header>
<S:Body Id=“MsgBody”>
<tru:StockSymbol xmlns:tru=“http://fabrikam123.com/payloads”>
QQQ
</tru:StockSymbol>
</S:Body>
</S:Envelope>
```

The SOAP message is in XML (Extensible Markup Language) format. An XML element begins with “<” followed by the name of the element. A one-line element may consist of a single set of brackets, such as <simple-element/>. A more complicated element may begin and end with pairs of brackets, such as <simple-element> . . . </simple-element>. Elements may contain values or attribute-value pairs, of the form “attribute=value.” Elements may themselves contain elements, and so on, recursively. For example, the envelope element contains (wraps) the entire message except for the first line.

The example SOAP message is composed of two portions. The header, which extends from line 5 to line 34 of page 11, contains administrative information about the processing of the message. One element of the header is the security element (line 6 to line 31). The security element contains the security information of the message.

Lines 8 through 11 contain a binary security token. A security token is an element used to prove the identity of a participant in the message or to provide evidence of trustworthiness. The ValueType attribute of the security token on line 8 indicates that the security token is an X.509 certificate. Lines 12 through 30 specify a digital signature. The signature uses the XML Signature specification. Lines 14 to 15 specify how to canonicalize or put into standard form the data that is being signed. Lines 16 to 17 specify the algorithm used to perform the signature.

The reference element (line 18) specifies the elements that are signed. In this case, an element named “MsgBody” is signed. That element is the body (line 33 to line 37) of the message. The DigestMethod element (lines 19 to 20) specifies the algorithm for taking the digest of the signed element. Line 21 provides the digest value and line 24 provides the value of the signature, the result of encrypting the digest value by the specified encryption method. The SecurityTokenReference (lines 26 to 28) specifies a security token that may prove that the claimed issuer of a public key used to verify the signature is indeed the issuer of the key. The body of the SOAP message is contained in line 33 to line 37. In this example, the body is not encrypted. Anyone who reads the message may understand the information in the body. In other messages, the body may be encrypted. In such a case, the security header may specify the encryption algorithm. The ID attribute of the body (line 33) specifies that the name of the body element is MsgBody. The signature element uses the name to refer to the body element.

The above example provides some idea of the amount of security information that a security generator such as security generator 320 may place in a network message. In the above example, the security information included a security token and a signature that used a cryptographic key. Producing the information required the application of several algorithms, including a digest method, a canonicalization method, and a signature method. Security generator 320 may produce these types of security information and apply these types of algorithms.

Security generator 320 may access configuration data 340 to simplify the task of generating the security information for inclusion in a message. Configuration data 340 may include specifications of cryptographic keys and specifications of formats to represent the information about the keys. Configuration data 340 includes deployment descriptor 350, binding 360, and platform configuration 370. Deployment descriptor 350 may describe the security requirements of messages; for instance, whether they are to be encrypted or signed. In some embodiments, deployment descriptor 350 may consist of a text or XML file. Deployment descriptor 350 may contain a list of keywords to describe security requirements.

Binding file 360 may contain organized sets of values of security parameters. A collection may, for example, represent the values of a common security setting for a particular application. The collections may be labeled and may be accessible by label. Platform configuration file 370 may also contain organized sets of values of security parameters. The platform configuration collections may represent default values for a platform.

Binding file 360 and platform configuration file 370 may be written in XML format. When configuration data 340 is used for the generation of security headers for SOAP messages, the contents of files 360 and 370 may resemble the contents of the security headers, such as the example security header shown above. The following example illustrates the information that may be contained in a binding file:

```
<securityRequestGeneratorBindingConfig
    xmi:id=
    “SecurityRequestGeneratorBindingConfig_1104952795718”>
<signingInfo xmi:id=“SigningInfo_1104952795718”
    name=“signing-info”>
  <signatureMethod xmi:id=“SignatureMethod_1104952795718”
    algorithm=“http://www.w3.org/2000/09/xmldsig#rsa-sha1”/>
  <canonicalizationMethod
    xmi:id=“CanonicalizationMethod_1104952795718”
    algorithm=“http://www.w3.org/2001/10/xml-exc-c14n#”/>
  <partReference xmi:id=“PartReference_1104952795718”
    part=“int” name=“part-ref”>
    <transform xmi:id=“Transform_1104952795718”
          algorithm=http://www.w3.org/2001/10/xml-exc-c14n#
          name=“transform”/>
    <digestMethod xmi:id=“DigestMethod_1104952795718”
          algorithm=“http://www.w3.org/2000/09/xmldsig#sha1”/>
  </partReference>
  <signingKeyInfo xmi:id=“SigningKeyInfo_1104952795718”
    keyinfoRef=“strref” name=“strref”/>
</signingInfo>
<keyInfo xmi:id=“KeyInfo_1104952795718” type=“STRREF” name=“strref”
    classname=
“com.ibm.ws.webservices.wssecurity.keyinfo.STRReferenceContentGenerator”>
  <keyLocatorMapping xmi:id=“KeyLocatorMapping_1104952795718”
          locatorRef=“dsig-sender” keynameRef=“CN=SOAPRequester, OU=TRL,
          O=IBM,ST=Kanagawa, C=JP”/>
    <tokenReference xmi:id=“TokenReference_1104952795718”
      tokenRef=“X509”/>
  </keyInfo>
  <keyLocator xmi:id=“KeyLocator_1104952795718” name=“dsig-sender”
      classname=“com.ibm.wsspi.wssecurity.keyinfo.KeyStoreKeyLocator”>
    <keyStore xmi:id=“KeyStore_1104952795718”
      storepass=“{xor}PDM2OjEr”
      path=“${USER_INSTALL_ROOT}/etc/ws-security/samples/dsig-sender.ks”
      type=“JKS”/>
    <keys xmi:id=“Key_1104952795718” alias=“soaprequester”
      keypass=“{xor}PDM2OjEr” name=“CN=SOAPRequester, OU=TRL, O=IBM,
      ST=Kanagawa, C=JP”/>
  </keyLocator>
  <tokenGenerator xmi:id=“TokenGenerator_1104952795718”
      name=“X509”
      classname=“com.ibm.wsspi.wssecurity.token.X509TokenGenerator”>
    <valueType xmi:id=“ValueType_1104952795718”
      localName=
      “http://docs.oasis-open.org/wss/2004/01/oasis-200401-wss-x509-token-
profile-1.0#X509”
      uri=“” name=“X509 certificate token”/>
    <callbackHandler xmi:id=“CallbackHandler_1104952795718”
  classname=“com.ibm.wsspi.wssecurity.auth.callback.X509CallbackHandler”>
      <key xmi:id=“Key_1104952795719” alias=“soaprequester”
          keypass=“{xor}PDM2OjEr” name=“CN=SOAPRequester, OU=TRL, O=IBM,
          ST=Kanagawa, C=JP”/>
      <keyStore xmi:id=“KeyStore_1104952795719”
      storepass=“{xor}PDM2OjEr”
      path=
          “${USER_INSTALL_ROOT}/etc/ws-security/samples/dsig-sender.ks”
      type=“JKS”/>
      <basicAuth xmi:id=“BasicAuth_1104952795718”/>
    </callbackHandler>
    <partReference xmi:id=“PartReference_1104952795719”/>
  </tokenGenerator>
</securityRequestGeneratorBindingConfig>
```

The entire example consists of a single XML element, a securityRequestGeneratorBindingConfig element. This element is a collection of values of security parameters. The securityRequestGeneratorBindingConfig contains a signingInfo element (lines 7 to 8) (the page is 14 when none is specified) which contains information about a digital signature, including the signature method (lines 9 and 10), the canonicalization method (lines 11 to 13), the transformation algorithm (lines 16 to 18), the digest method (lines 19 to 20), and information about the key used to produce a signature (lines 22 to 23). The keyinfo element (lines 25 to 33) may contain information about a key used to encrypt the body of a message. The key locator element (line 34, page 14 to line 6, page 15) may describe a module to retrieve keys from a key store (line 36, page 14 to line 2, page 15). The key locator element also contains a designation of a particular key available in the key store (lines 3 to 5, page 15). The token generator element (lines 7 to 28, page 15) contains information about the generation of security tokens for insertion in a message. In the above example, each element was labeled with the value of the xmi:id attribute of the element. For example, the KeyInfo element was labeled “KeyInfo_{—}1104952795718” and the tokenReference element was labeled “TokenReference_{—}1104952795718”. In some embodiments, the labels may be used to retrieve the elements.

The organization of the above example binding file may enable a user to specify three attributes of a signature or encryption key in a flexible manner:
(1) what key is used,
(2) what kind of security token is used to specify the key, and
(3) how the security token appears in the transmitted message.
   (1) may be specified by the keyLocator element. In the example binding file, the KeyLocator element provides access to keys stored in a key file by specifying a file name (lines 1-2, page 15) and a password (line 37, page 14) to access the file. (2) may be specified by the tokenGenerator element. In the example binding file, the token type is BinarySecurityToken which contains an X.509 certificate. A file name and password to access a file storing the certificate are specified. (3) is specified by the keyInfo element, specifically with its “type” attribute (line 25, page 14). Since there are only several ways to embed tokens in messages, type names may be prepared for the attribute values. “STRREF” indicates that there is a token element in the message and the token is referenced from KeyInfo element. See SecurityTokenReference in the message example (lines 26 to 28, page 11). Note that the keyInfo element of the binding file refers to keyLocator (lines 28 to 30, page 14) and tokenGenerator (lines 31-32). In this way, these three elements of security information are properly associated while they may be specified independently.

This example is for illustration and not limitation. A configuration data file may contain security information other than that displayed above, may omit security information displayed above, and may represent the security information in formats other than those used above. In some embodiments, a configuration file may contain complete information for generating and consuming security information based on the Web Service Security 1.0 specification from OASIS. The security information contained in a configuration data file may describe how to use cryptographic keys, how to sign or encrypt Web services messages, how the keys are to be referenced or included in the messages, and what tokens to use in messages.

Returning to FIG. 3, after accessing configuration data file 340, security generator 320 may determine security requirements for application message 310 and may specify values of parameters under the security protocol involved in transmitting application message 310. Security generator 320 may also perform additional processing, such as using a cryptographic key obtained from configuration data 340 to encrypt or sign application message 310. The result of the processing is message with security 330, a message with security information.

The utilization of configuration data file 340 may simplify the process of inserting security information in messages. Security generator 320 may refer to a complex element of configuration data file 340 by the label, rather than generating all of the components of the element. In addition, the data in binding file 360 and platform configuration file 370 may be shareable across multiple applications. A change in security procedures may be implemented by making a change in configuration data file 340 rather than by rewriting the code of multiple applications. Similarly, a change may be implemented by changing the contents of web sites referred to be configuration data file 340.

The components of FIG. 3 and their arrangement are for illustration and not limitation. In other embodiments, message security generators may contain different components than those shown in FIG. 3, or may contain the same components organized in a different manner as will occur to those of skill in the art.

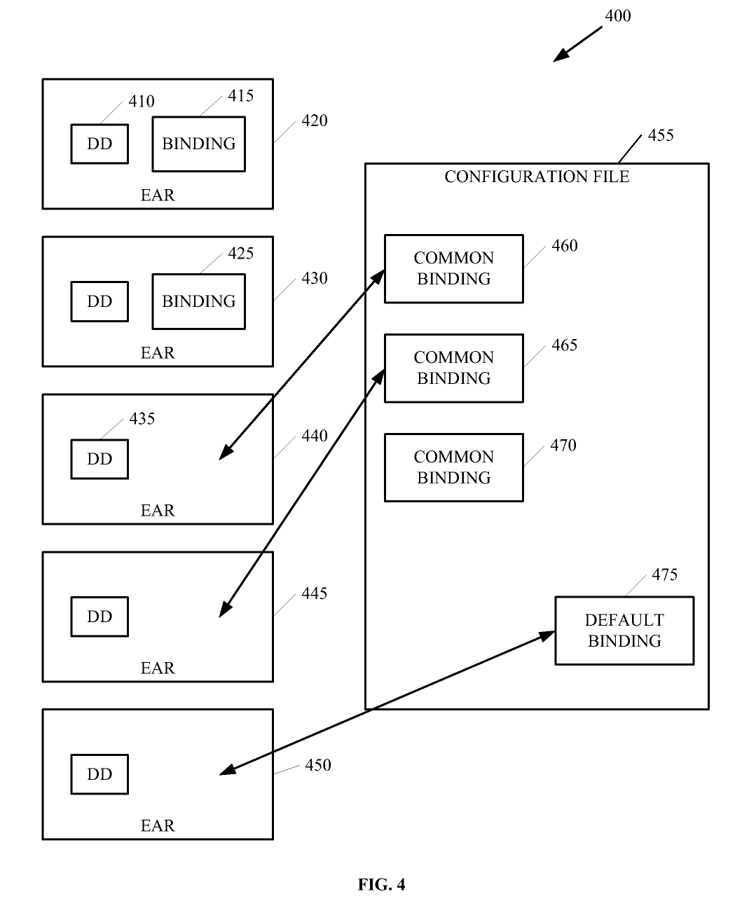

FIG. 4 is a diagram 400 of the specification of bindings from collections of prepared bindings. FIG. 4 includes multiple applications 420, 430, 440, 445, and 450 and a configuration file 455. The applications 420, 430, 440, 445, and 450 may generate messages containing security information. The applications 420, 430, 440, 445, and 450 may consist of Java Platform, Enterprise Edition applications packaged as Enterprise Archive (EAR) files. The EAR files may contain deployment descriptors (DDs) such as DD 410 and DD 435. The DDs, such as DD 410 and DD 435, may describe the deployment settings of the applications. The DDs, such as DD 410 and DD 435, may also describe the security requirements of messages generated by the applications.

The applications 420, 430, 440, 445, and 450 may utilize collections of prepared bindings, such as bindings 415 and 425, in the production of security information, such as SOAP security headers for inclusion in messages. Some of the EAR files may contain application-specific bindings, such as bindings 415 and 425 in applications 420 and 430 respectively. Other EAR files may use collections of bindings common to multiple applications (common bindings). It is common for different deployment descriptors to share a binding. For example, although a signature may be performed on different parts of a message, the process of signing the different parts may be the same, i.e., the signatures may use the same algorithm, the same signing key, and so on.

Configuration file 455 includes collections of common bindings 460, 465, and 470. As illustrated by the arrows, in FIG. 4, application 440 uses common binding 460, and application 445 uses common binding 465. Configuration file 455 also includes default binding 475, the binding to be used when no other binding is specified. In FIG. 4, application 450 uses default binding 475. The flow of data between applications and configuration file 455 may be two-way. An application may create a collection of bindings and store it in configuration file 455 for use by other applications.

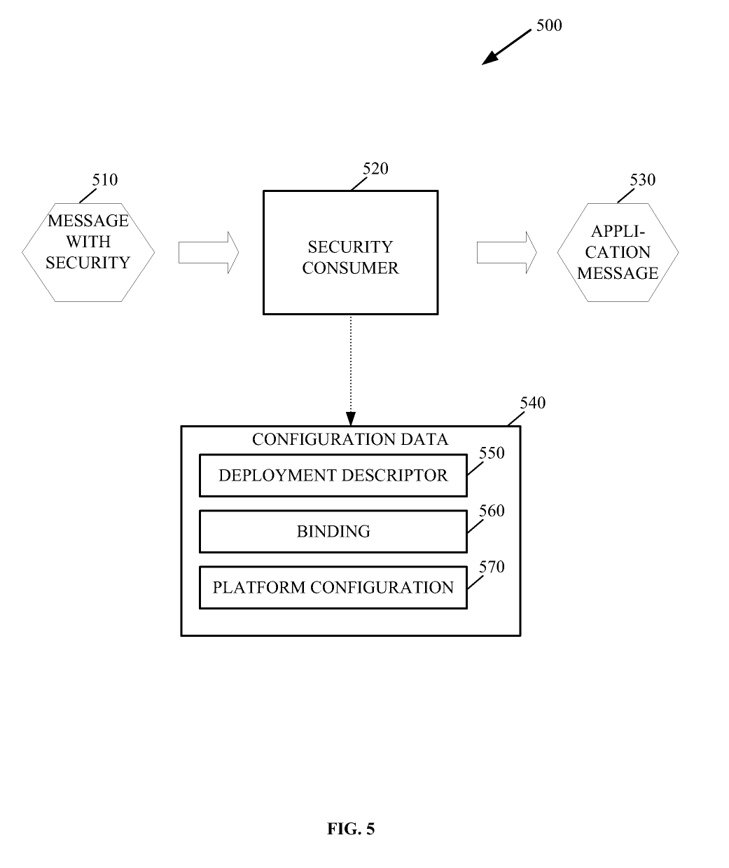

Turning to FIG. 5, depicted is a process flow diagram 500 of the processing or consumption of security information in a message. FIG. 5 includes message with security 510, security consumer 520, application message 530, and configuration data 540. Message with security 510 is a message containing security information that was transmitted over a network. For example, message with security 510 may be a SOAP message with a SOAP security header.

Message with security 510 is received by security consumer 520. Security consumer 520 may process the security information contained in message with security 510. The processing may include decrypting message with security 510, if the message was encrypted, and verifying the signature information, if message with security 510 was signed. The processing may include establishing the identity of the sender of the message or another party to the message. The processing may also include determining the degree of trust to place in message with security 510. Responding to an untrustworthy message may cause harm. The message may request confidential information, request expensive computer processing services, or may request changes to a data base containing sensitive data, such as information about bank accounts. The processing by security consumer 520 includes accessing configuration data 540.

Configuration data 540 contains security information for use by security consumer 520 in generating messages. The information may include a policy or policies about the degree of trust to be given to messages. A policy may specify a list of trusted senders, a list of trusted certification authorities, or a combination of both. For example, a message may be trusted if the sender can produce a chain of endorsements by certification authorities beginning with a trusted endorsement. The degree of trust provided a message, such as message with security 510, may be based upon security tokens contained in the message.

In particular, the policy may describe the treatment of a message containing multiple security tokens. When a message requesting Web services travels via an intermediary or intermediaries, such as intermediary server 125 in FIG. 1, the message may contain tokens of the original requester and the intermediary or intermediaries. In that case, a security policy may direct the selection of a token to identify the requester, and may also specify the selection of a token for determining a degree of trust. For example, the policy may select a username in a UsernameToken element, and may trust an intermediary based on its digital signature and a token that is a part of the digital signature.

More generally, configuration data 540 may contain a complete set of policies for processing security information. The policies may describe the security features required in a network message and how to process the security information provided in the network message. For example, security consumer 520 may process SOAP messages containing requests for Web Services. The policies specified in configuration data 540 may require the security information in the messages to comply with the WSS specification for security for Web services. The policies may specify the selection of a token to determine the identity of a requester when a message contains multiple messages.

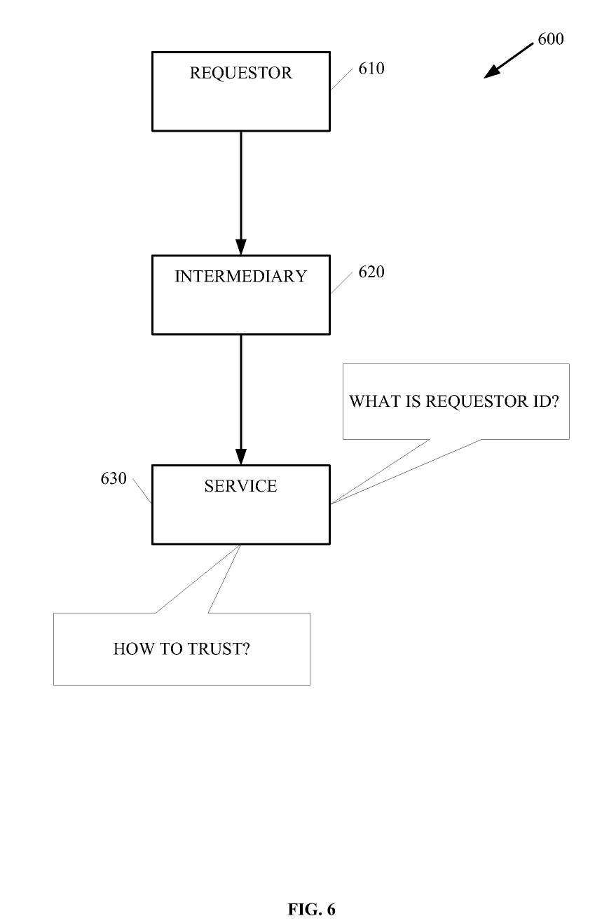

Turning to FIG. 6, depicted is a diagram 600 illustrating the processing of security information by a consumer of security information such as security consumer 520. FIG. 6 includes a requester 610, an intermediary 620, and a service 630. Requestor 610 may generate a request, such as a request for Web services. Intermediary 620 may receive the request, perform processing, and forward the request to service 630. The request may contain security information. In processing the request, service 630 may attempt to determine the identity of the requester 610 and the degree of trust to place in the message.

Returning to FIG. 5, configuration data 540 includes deployment descriptor 550, binding 560, and platform configuration 570. Deployment descriptor 550 may describe the security requirements of messages. In some embodiments, deployment descriptor 550 may consist of a text or XML file. Deployment descriptor 550 may contain a list of keywords to describe security requirements. Binding file 560 may contain organized sets of values of security parameters. Platform configuration file 570 may also contain organized sets of values of security parameters. The platform configuration collections may represent default values for a platform.

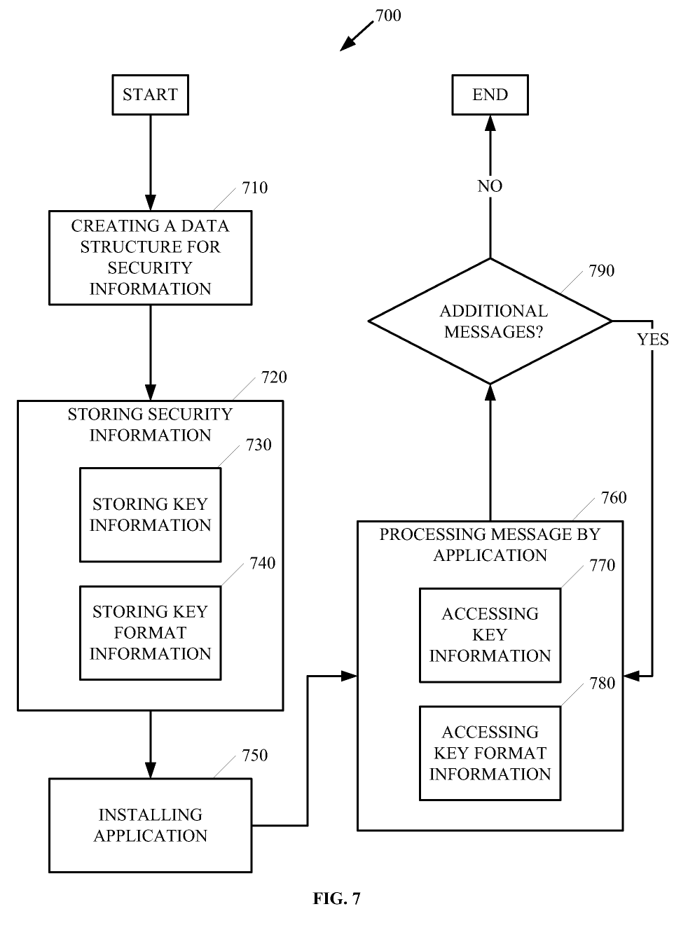

Turning to FIG. 7, depicted is a flowchart 700 of an embodiment to configure an application to generate security information. Flowchart 700 begins with creating a data structure to store information used to provide security for messages to be transmitted over a network (element 710). The data structure may contain specifications of the security requirements for the messages. The data structure may also contain values of parameters of security information to be inserted in the messages, such as the values of parameters of security parameters in the headings of SOAP messages.

Flowchart 700 includes storing security information in the data structure (element 720). The storing may include storing specifications of cryptographic keys (element 730) and specifications of formats for the representation of information about cryptographic keys (element 740). Flowchart 700 includes installing an application (element 750). The installation may include making security data from the security data file available to the application. For example, bindings may be placed in a deployment descriptor file for the application.

The application may generate a message and provide security for the message (element 760). The provision of security information may include accessing information about cryptographic keys (element 770). The application may access the data structure of element 710 or may access some other file, such as a deployment descriptor file for the application, in which the information has been placed. The application may also access information about the format in which the key information is stored (element 780). If there are additional messages (element 790), elements 760 through 780 may be repeated. If there are no additional messages, the generation of security information may end.

The elements of flowchart 700 are for illustration and not for limitation. In alternative embodiments, some of the elements of flowchart 700 may be omitted or others may be added. For example, in some embodiments, a message may be signed or encrypted or both. In many embodiments, a message may be sent with security tokens.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present invention contemplates methods and arrangements to handle messages containing security information. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method to configure an application to generate security information of network messages, the method comprising:
creating a data structure to store security information of network messages;
storing security information in the data structure, the security information including a specification of a cryptographic key and a specification of a format to represent information about the cryptographic key; and
generating by the application security information of a network message, the generating comprising accessing by the application the specification of a cryptographic key and the specification of a format.

2. The method of claim 1, further comprising installing the application, the installation comprising accessing the data structure.

3. The method of claim 1, further comprising:
generating security information of another network message, the generating comprising accessing by another application the specification of a cryptographic key and the specification of a format.

4. The method of claim 1, wherein storing security information comprises:
storing security information in Extensible Markup Language (XML) format.

5. The method of claim 1, wherein storing security information comprises storing information about finding a cryptographic key.

6. The method of claim 1, wherein storing security information comprises storing information about representing a cryptographic key via a security token.

7. The method of claim 1, wherein storing security information comprises storing information about a format of reference to a security token in a network message.

8. The method of claim 1, wherein storing security information comprises:
storing a collection of bindings, the bindings specifying parameters of security information; and
labeling the collection of bindings.

9. The method of claim 8, wherein the generating comprises accessing the collection of bindings by specifying the label of the collection of bindings.

10. The method of claim 8, further comprising generating security information of another network message, the generating comprising accessing by another application the collection of bindings.

11. The method of claim 1, wherein the storing comprises storing the specification of a cryptographic key to use in encryption.

12. The method of claim 1, wherein the storing comprises storing the specification of a cryptographic key to use in the production of digital signatures.

13. The method of claim 1, wherein:
the storing comprises storing security information to generate a complete security header compliant with the Web Services Security specification (WSS); and
the generating comprises accessing the security information to generate a complete security header compliant with WSS.

14. A method to configure an application to process network messages, the method comprising:
creating a data structure to store security information of network messages;
storing security information in the data structure, the security information including a specification of a method to select a security token of a requester when multiple security tokens are contained in network messages; and
processing a network message, the processing comprising the application applying the method to select a security token of a requestor.

15. The method of claim 14, wherein:
the storing further comprises storing a specification of an method to authenticate a sender of the network message; and
the processing further comprises the application applying the method to authenticate a sender.

16. The method of claim 14, wherein:
the storing further comprises storing a specification of an method to select a token to determine a degree of trust; and
the processing further comprises the application applying the method to select a token to determine a degree of trust.

17. An apparatus to configure an application to generate security information of network messages, the apparatus comprising:
a storage to store security information of network messages, the security information to include a specification of a cryptographic key and a specification of a format to represent information about the cryptographic key; and
a processor to process network messages, the processing to include deploying the application and accessing by the application the specification of a cryptographic key and the specification of a format.

18. The apparatus of claim 17, the storage comprising:
a deployment descriptor storage to store specifications of security requirements;
a binding storage to store values of parameters of security information; and
a platform level storage to store platform-specific security information.

19. The apparatus of claim 18, wherein the binding storage comprises a module to store collections of bindings and to label the collections of bindings, the bindings specifying values of parameters of security information.

20. The apparatus of claim 19, wherein the processing module comprises a reference module to access collections of bindings by label.

21. An apparatus to configure an application to process network messages, the apparatus comprising:
a storage to store security information of network messages, the security information to include a specification of a method to select a security token of a requester when multiple security tokens are contained in network messages, wherein the storage comprises:
a deployment descriptor to store specifications of security requirements;
a binding storage to store values of parameters of security information; and
a platform level storage to store platform-specific security information; and
a processor to process network messages, the processing to include deploying the application and accessing by the application the method to select a security token of a requestor.

22. The apparatus of claim 21, wherein:
the storage comprises a module to store a specification of a method to authenticate a sender of the network message; and
the processor further comprises logic of the application to carry out the method to authenticate the sender.

23. The apparatus of claim 21, wherein:
the storage comprises a module to store a specification of a method to select a token to determine a degree of trust; and
the processor further comprises logic of the application to carry out the method to select a token to determine a degree of trust.

24. A computer program product to configure an application to generate security information of network messages, the computer program comprising a computer useable medium having a computer readable program, wherein the computer readable program when executed on a computer causes the computer to:
create a data structure to store security information of network messages;
store security information in the data structure, the security information including a specification of a cryptographic key and a specification of a format to represent information about the cryptographic key; and
generate by the application security information of a network message, the generating comprising accessing by the application the specification of a cryptographic key and the specification of a format.

25. The computer program product of claim 24, wherein the computer readable program when executed on a computer further causes the computer to generate security information of another network message, the generating comprising accessing by another application the specification of a cryptographic key and the specification of a format.

26. The computer program product of claim 24, wherein the computer readable program which causes the computer to store security information comprises a computer readable program which causes the computer to:
store a collection of bindings, the bindings specifying parameters of security information; and
label the collection of bindings.

27. The computer program product of claim 26, wherein the computer readable program which causes the computer to generate by the application security information of a network message comprises a computer readable program which causes the computer to access the collection of bindings by specifying a label of the collection of bindings.

28. The computer program product of claim 24, wherein:
the computer readable program which causes the computer to store security information comprises a computer readable program which causes the computer to store security information to generate a complete security header compliant with the Web Services Security specification (WSS); and
the computer readable program which causes the computer to generate by the application security information of a network message comprises a computer readable program which causes the computer to access the security information to generate a complete security header compliant with WSS.

29. The computer program product of claim 24, wherein the computer useable medium comprises a transmission medium.

30. The computer program product of claim 24, wherein the computer readable program which causes the computer to store security information comprises a computer readable program which causes the computer to store information about finding a cryptographic key.

31. The computer program product of claim 24, wherein the computer readable program which causes the computer to store security information comprises a computer readable program which causes the computer to store information about representing a cryptographic key via a security token.

32. The computer program product of claim 24, wherein the computer readable program which causes the computer to store security information comprises a computer readable program which causes the computer to store information about a format of a reference to a security token in a network message.

33. The computer program product of claim 24, wherein:
the computer readable program which causes the computer to store security information comprises a computer readable program which causes the computer to store a specification of a method to select a security token of a requestor when multiple security tokens are contained in network messages; and
the computer readable program causes the computer to process a network message, the processing comprising the application applying the method to select a security token of a requestor.

34. The computer program product of claim 33, wherein:
the computer readable program which causes the computer to store security information comprises a computer readable program which causes the computer to store a specification of an method to authenticate a sender of the network message; and
the computer readable program which causes the computer to process a network message further comprises a computer readable program which causes the computer to apply the method to authenticate a sender by executing the application.

35. The computer program product of claim 33, wherein:
the computer readable program which causes the computer to store security information comprises a computer readable program which causes the computer to store a specification of an method to select a token to determine a degree of trust; and
the computer readable program which causes the computer to process a network message further comprises a computer readable program which causes the computer to apply the method to select a token to determine a degree of trust by executing the application.
